(19) United States
(12) Patent Application Publication
(10) Pub. No.: US 2021/0023504 A1
(43) Pub. Date: Jan. 28, 2021

(54) MEMBRANE ELEMENT AND FILTER CARTRIDGE

(71) Applicant: A. O. SMITH CORPORATION, Milwaukee, WI (US)

(72) Inventors: Ke SHEN, Nanjing (CN); Yizhi HOU, Nanjing (CN); Chen WANG, Nanjing, Jiangsu Province (CN)

(21) Appl. No.: 16/638,426

(22) PCT Filed: Aug. 21, 2018
(86) PCT No.: PCT/CN2018/101508

§ 371 Date: Aug. 18, 2020

(30) Foreign Application Priority Data
Aug. 21, 2017 (CN) 201710719677.4
Aug. 21, 2017 (CN) 201721047437.6
Aug. 21, 2017 (CN) 201721047971.7
Dec. 1, 2017 (CN) 201721647839.X

(51) Int. Cl. B01D 63/12; B01D 61/02; C02F 1/44

(52) U.S. Cl. CPC B01D 63/12; B01D 61/027; B01D 61/025; B01D 61/022; C02F 1/441; C02F 1/442; C02F 2201/004; B01D 2313/04; B01D 2313/08; B01D 2319/022; B01D 2319/06; C02F 2301/08; C02F 2201/006; B01D 2313/21

(57) ABSTRACT

The present application discloses a membrane element and a filter cartridge, wherein the membrane element comprises: a water collecting pipe; and a first membrane unit and a second membrane unit rolled on the water collecting pipe together, a waste water outlet of the first membrane unit being in communication with a raw water inlet of the second membrane unit, the waste water outlet of the first membrane unit and the raw water inlet of the second membrane unit being located a same side edge corresponding thereto when the first membrane unit and the second membrane unit are in an unrolled state. The first membrane unit and the second membrane unit may be rolled on the water collecting pipe together at one time. In this embodiment, the membrane element in the embodiment of the present application can improve a surface flow rate of the membrane element, thereby improving the anti-containment performance of the membrane and extending the service life of the membrane, while the production of pure water of the membrane element remains unchanged under the same water intake pressure.

### CROSS REFERENCE TO RELATED APPLICATIONS

This application is a continuation of International Application No. PCT/CN2018/101508 filed on Aug. 21, 2018, which claims priority to Chinese Patent application No. 201721047971.7, No. 201710719677.4 and No. 201721047437.6, entitled “membrane Element and Filter Cartridge”, submitted on Aug. 21, 2017, and claims the priority of the Chinese patent application No. 201721647839.X, entitled “membrane Element and Filter Cartridge”, submitted on Dec. 1, 2017, and the entire contents thereof are incorporated by reference in the present application.

### TECHNICAL FIELD

The present application relates to the field of water treatment, in particular to a membrane element and a filter cartridge.

### BACKGROUND

In the prior art, rolled-up type membrane elements are usually used for filtering water. The front-side interlayer of the membrane element forms a raw water flow channel, while the back-side interlayer of the membrane element forms a pure water flow channel.

In general, in case of the same membrane area, the longer the membrane page is, the longer the raw water flow channel is, and the less the membrane page is, the greater the membrane surface flow rate is. Membrane elements with greater membrane surface flow rates will provide stronger scouring intensity to pollutants attached to the membrane surface, and thus have better anti-contamination performance and longer service life. In the membrane elements in the prior art, the length of the raw water flow channel corresponds to that of the pure water flow channel. When the length of the raw water flow channel of a single membrane element is too long, the length of the corresponding pure water flow channel is also too long, resulting in a relatively large back pressure on the pure water side of the membrane element, causing a decrease in production of pure water of the membrane under the same water pressure.

In addition, the problems of how to make the volume of the membrane element smaller or how to make the manufacturing method of the membrane element simpler are also technical problems that need to be solved by those skilled in the art.

### SUMMARY

In order to overcome the above deficiencies in the prior art, the present application solves the technical problem of providing a membrane element and a filter cartridge which can solve at least one of the above technical problems.

The specific technical solutions of the present application are as follows.

The present application provides a membrane element, comprising:

a water collecting pipe;

a first membrane unit and a second membrane unit rolled on the water collecting pipe together;

a waste water outlet of the first membrane unit being in communication with a raw water inlet of the second membrane unit, the waste water outlet of the first membrane unit and the raw water inlet of the second membrane unit being located on a same side edge corresponding thereto when the first membrane unit and the second membrane unit are in an unrolled state.

Preferably, the first membrane unit and the second membrane unit are rolled on the water collecting pipe together at one time.

Preferably, the first membrane unit and second membrane unit are provided in a stacking manner when the membrane element is in the unrolled state.

Preferably, the membrane element, in the unrolled state, has a first side edge connected to the water collecting pipe and a second side edge opposite to the first side edge; the waste water outlet of the first membrane unit and the raw water inlet of the second membrane unit are located on the second side edge in the unrolled state.

Preferably, the membrane element, in the unrolled state, has a third side edge and a fourth side edge that are opposite to each other, the third side edge and the fourth side edge being respectively connected to the first side edge and the second side edge, the raw water inlet of the first membrane unit is provided on a part of the third side edge adjacent to the first side edge, and the waste water outlet of the second membrane unit being provided on a part of the fourth side edge adjacent to the first side edge.

Preferably, the third side edge of the first membrane unit on the side of the raw water flow channel is sealed except the raw water inlet of the first membrane unit, and the fourth side edge of the second membrane unit on the side of the raw water flow channel is sealed; the fourth side edge of the second membrane unit on the side of the raw water flow channel is sealed except the waste water outlet of the second membrane unit, and the third side edge of the second membrane unit on the side of the raw water flow channel is sealed.

Preferably, a part of the third side edge of the first membrane unit on the side of the raw water flow channel other than the raw water inlet of the first membrane unit and a part of the third side edge of the second membrane unit on the side of the raw water flow channel other than the part corresponding to the raw water inlet of the first membrane unit are sealed by a first end cap, and a part of the third side edge of the second membrane unit corresponding to the raw water inlet of the first membrane unit is sealed on a surface of the second membrane unit on the side of the raw water flow channel adjacent to the third side edge.

Preferably, a part of the fourth side edge of the second membrane unit on the side of the raw water flow channel other than the waste water outlet of the second membrane unit and a part of the fourth side edge of the second membrane unit on the side of the raw water flow channel other than the part corresponding to the waste water outlet of the second membrane unit are sealed by a second end cap, and a part of the fourth side edge of the first membrane unit corresponding to the waste water outlet of the second membrane unit is sealed on a surface of the first membrane unit on the side of the raw water flow channel adjacent to the fourth side edge.

Preferably, the waste water outlet of the first membrane unit and the raw water inlet of the second membrane unit are located on one end of the membrane element, and the raw water inlet of the first membrane unit and the waste water outlet of the second membrane unit are located on the other end of the membrane element. Preferably, the membrane element, in the unrolled state, has a first side edge connected to the water collecting pipe and a second side edge opposite to the first side edge, and the membrane element, in the unrolled state, also has a third side edge and a fourth side edge that are opposite to each other, the third side edge and the fourth side edge being respectively connected to the first side edge and the second side edge, and, the waste water outlet of the first membrane unit is provided on a part of the fourth side edge adjacent to the second side edge, the raw water inlet of the second membrane unit is provided on a part of the fourth side edge adjacent to the first side edge, the raw water inlet of the first membrane unit is provided on a part of the third side edge adjacent to the first side edge, and the waste water outlet of the second membrane unit is provided on a part of the third side edge adjacent to the second side edge.

Preferably, a part of the third side edge on the raw water flow channel of the first membrane unit other than the raw water inlet of the first membrane unit is sealed, and a part of the fourth side edge on the raw water flow channel of the first membrane unit other than the waste water outlet of the first membrane unit is sealed; a part of the fourth side edge of the second membrane unit on the side of the raw water flow channel other than the raw water inlet of the second membrane unit is sealed, a part of the third side edge of the second membrane unit on the side of the raw water flow channel other than the waste water outlet of the second membrane unit is sealed, and the second side edge of the membrane element is sealed.

Preferably, a part of the third side edge of the first membrane unit on the side of the raw water flow channel other than the raw water inlet of the first membrane unit and the part corresponding to the waste water outlet of the second membrane unit and a part of the third side edge of the second membrane unit on the side of the raw water flow channel other than the part corresponding to the raw water inlet of the first membrane unit and the waste water outlet of the second membrane unit are sealed by an end cap; a part of the third side edge of the first membrane unit corresponding to the waste water outlet of the second membrane unit is sealed on a surface of the first membrane unit on the side of the raw water flow channel adjacent to the third side edge; and a part of the third side edge of the second membrane unit corresponding to the raw water inlet of the first membrane unit is sealed on a surface of the second membrane unit on the side of the raw water flow channel adjacent to the third side edge.

Preferably, a part of the fourth side edge of the second membrane unit on the side of the raw water flow channel other than the waste water outlet of the first membrane unit and the part corresponding to the raw water inlet of the second membrane unit and a part of the fourth side edge of the second membrane unit on the side of the raw water flow channel other than the part corresponding to the waste water outlet of the first membrane unit and the raw water inlet of the second membrane unit are sealed by an end cap; a part of the fourth side edge of the first membrane unit corresponding to the raw water inlet of the second membrane unit is sealed on a surface of the first membrane unit on the side of the raw water flow channel adjacent to the fourth side edge; and a part of the fourth side edge of the second membrane unit corresponding to the waste water outlet of the first membrane unit is sealed on a surface of the second membrane unit on the side of the raw water flow channel adjacent to the fourth side edge.

Preferably, the membrane element further comprises a first end cap and a second end cap provided on two ends of the water collecting pipe, the first end cap has a first opening in communication with the raw water inlet of the first membrane unit and a second opening in communication with the waste water outlet of the second membrane unit, and the second end cap has a third through-hole in communication with the waste water outlet of the first membrane unit and a fourth through-hole in communication with the raw water inlet of the second membrane unit.

Preferably, the first membrane unit and the second membrane unit are arranged in parallel in an axial direction of the water collecting pipe, the membrane element, in the unrolled state, has a first side edge connected to the water collecting pipe and a second side edge opposite to the first side edge, and the waste water outlet of the first membrane unit and the raw water inlet of the second membrane unit are located on the second side edge in the unrolled state; the membrane element, in the unrolled state, has a third side edge and a fourth side edge that are opposite to each other, the third side edge and the fourth side edge are respectively connected with the first side edge and the second side edge, the raw water inlet of the first membrane unit is provided on a part of the third side edge adjacent to the first side edge, and the waste water outlet of the second membrane unit is provided on a part of the fourth side edge adjacent to the first side edge.

Preferably, the membrane unit has a first end and a second end that are opposite to each other along the axial direction of the water collecting pipe, and the second membrane unit has a third end and a fourth end that are opposite to each other along the axial direction of the water collecting pipe, wherein, the second end of the first membrane unit and the third end of the second membrane unit are provided opposite to each other;

the membrane element comprises a first end cap, a second end cap, a third end cap and a fourth end cap, which are respectively and correspondingly provided on the first end and the second end of the first membrane unit, and on the third end and the fourth end of the second membrane unit;

a part of the third side edge of the first membrane unit on the side of the raw water flow channel other than the raw water inlet of the first membrane unit is sealed by the first end cap;

the fourth side edge of the second membrane unit on the side of the raw water flow channel is sealed by the second end cap;

the third side edge on the side of the raw water flow channel of the second membrane unit is sealed by the third end cap;

a part of the fourth side edge on the side of the raw water flow channel of the second membrane unit other than the waste water outlet of the second membrane unit is sealed by the fourth end cap.

Preferably, the membrane element, in the unrolled state, has a first side edge connected to the water collecting pipe and a second side edge opposite to the first side edge, the waste water outlet of the first membrane unit and the raw water inlet of the second membrane unit are located on the second side edge in the unrolled state, and the membrane element comprises a membrane shell between which and an outer wall surface of the first membrane unit and/or the second membrane unit a third space is formed.

Preferably, the first membrane unit and the second membrane unit are made of the same or different filtering membrane material.

Preferably, the first membrane unit is a nanofiltration membrane and the second membrane unit is a reverse osmosis membrane.

Preferably, a membrane area of the first membrane unit is less than a membrane area of the second membrane unit.

Preferably, the first membrane unit and the second membrane unit are both reverse osmosis membrane.

Preferably, a membrane area of the first membrane unit is greater than a membrane area of the second membrane unit.

Preferably, the number of the first membrane unit is plural, and the plurality of the first membrane units are made of the same or different filtering membrane materials.

Preferably, the number of the second membrane unit is plural, and the plurality of the second membrane units are made of the same or different filtering membrane materials.

Preferably, the raw water flow channels of both the first membrane unit and the second membrane unit spirally extend in the circumferential direction of the water collecting pipe.

The present application also discloses a membrane unit comprising: at least one water collecting pipe, a first membrane unit rolled on the water collecting pipe and a second membrane unit rolled on the water collecting pipe, at least one raw water flow channel of the first membrane unit and the second membrane unit spirally extending in a circumferential direction of the water collecting pipe, and a waste water outlet of the first membrane unit being in communication with a raw water inlet of the second membrane unit.

An embodiment of the present application also discloses a filter cartridge comprising a membrane element as described above.

In this embodiment, the pure water flow channel of the membrane element in the embodiment of the present application remains unchanged, thus the back pressure of pure water remains unchanged. By serial connections of the membrane surfaces, the number of the raw water intake pages is decreased, the raw water flow channel is extended, thereby the surface flow rate of the membrane element is increased, the anti-contamination performance of the membrane is improved, and the service life of the membrane is prolonged, while the production of pure water of the membrane element under the same water intake pressure is unchanged. In addition, the manufacturing method of the membrane element in the embodiments of the present application is relatively simple. The volume of the membrane element in the embodiments of the present application is relatively small.

### BRIEF DESCRIPTION OF THE DRAWINGS

The figures described herein are for explanation purposes only and are not intended to limit the scope of disclosure of the present application in any way. In addition, the shapes, proportions and sizes of the parts in the figures are only schematic to help understanding the present application, rather than to specifically define the shapes, proportions and sizes of the parts in the present application. Those skilled in the art, under the teaching of the present application, can select various possible shapes, proportions and sizes according to the specific situations to implement the present application.

FIG. 1 shows a schematic structure diagram of a membrane element in the embodiments of the present application in an unrolled state;

FIG. 2 shows a front view of a membrane element in a specific embodiment in FIG. 1 in the unrolled state;

FIG. 3 shows a front view of a membrane element in another specific embodiment in FIG. 1 in the unrolled state;

FIG. 4 shows a schematic principle diagram of flow paths of the membrane element in FIG. 2;

FIG. 5 shows a schematic principle diagram of the membrane element in FIG. 1 in the unrolled state;

FIG. 6 shows a structure diagram of a membrane element with a membrane shell and having a similar structure to the membrane element in FIG. 1;

FIG. 7 shows a schematic structure diagram of a membrane element in another embodiment of the present application;

FIG. 8 shows a schematic fluid diagram of the membrane element in FIG. 7;

FIG. 9 shows a structure diagram of a membrane element with a membrane shell and having a similar structure to the membrane element in FIG. 1;

FIG. 10 shows a schematic structure diagram of a membrane element in another embodiment of the present application in the unrolled state;

FIG. 11 shows a front view of a membrane element in a specific embodiment in FIG. 10 in the unrolled state;

FIG. 12 shows a front view of a membrane element in another specific embodiment in FIG. 10 in the unrolled state;

FIG. 13 shows a specific schematic structure diagram of the membrane element in FIG. 10;

FIG. 14 shows a schematic principle diagram of flow paths of the membrane element in FIG. 10;

FIG. 15 shows a schematic structure diagram of a membrane element in another embodiment of the present application;

FIG. 16 shows a schematic principle diagram of flow paths of the membrane element in FIG. 15;

FIG. 17 shows a specific schematic structure diagram of the second central pipe in FIG. 15;

FIG. 18 shows a section view of FIG. 17;

FIG. 19 shows another specific schematic structure diagram of the second central pipe in FIG. 15;

FIG. 20 shows a section view of FIG. 19;

FIG. 21 shows a schematic structure diagram of the lower half of the membrane element in FIG. 15;

FIG. 22 shows a schematic structure diagram of the upper half of the membrane element in FIG. 15;

FIG. 23 shows a schematic structure diagram of a membrane element in another embodiment of the present application;

FIG. 24 shows a schematic structure diagram of the lower half of the membrane element in FIG. 23;

FIG. 25 shows a schematic structure diagram of the upper half of the membrane element in FIG. 23;

FIG. 26 shows a schematic structure diagram of a membrane element in another embodiment of the present application;

FIG. 27 shows a schematic diagram of flow paths of the membrane element in FIG. 26;

FIG. 28 shows a schematic structure diagram of a membrane element in another embodiment of the present application;

FIG. 29 shows a schematic structure diagram of a membrane element in another embodiment of the present application;

FIG. 30 shows a schematic structure diagram of a membrane element in another embodiment of the present application;

Reference signs in the above figures: 1. water collecting pipe; 11. first central pipe; 12. second central pipe; 111. first pure water flow guiding channel; 112. second pure water flow guiding channel; 113. first channel; 114. second channel; 15. through-hole; 18. pure water; 2. first membrane unit; 21. raw water inlet of the first membrane unit; 22. waste water outlet of the first membrane unit; 24. raw water; 28. waste water; 3. second membrane unit; 31. raw water inlet of the second membrane unit; 32. waste water outlet of the second membrane unit; 5. membrane shell; 61. first through-hole; 62. second through-hole; 63. interlayer; 65. first gap space; 66. second gap space; 71. first side edge; 72. second side edge; 73. third side edge; 74. fourth side edge; 81. first end cap; 82. second end cap; 83. third end cap; 84. fourth end cap; 91. first cap body; 92. second cap body; 93. third cap body; 94. fourth cap body; 95. fifth cap body; 96. first space; 97. second space; 98. fifth through-hole; 981. third through-hole; 982. fourth through-hole; 99. fourth channel; 101. first water pipe; 102. second water pipe.

### DETAILED DESCRIPTION

The details of the present application can be understood more clearly by combining the accompanying drawings and the description of the specific embodiments of the present application. However, the specific embodiments described here are only for the purpose of explaining the present application, and cannot be understood as limitations to the present application in any way. Under the teaching of the present application, skilled persons can conceive of any possible transformations based on the present application, which should all be regarded as belonging to the scope of the present application.

The embodiments of the present application disclose a membrane element comprising: at least one water collecting pipe 1, and a first membrane unit 2 and a second membrane unit 3 rolled on the water collecting pipe 1 together.

The embodiments of the present application disclose a membrane element comprising: at least one water collecting pipe 1, a first membrane unit 2 rolled on the water collecting pipe 1, and a second membrane unit 3 rolled on the water collecting pipe 1.

Raw water flow channels of the first membrane unit 2 and the second membrane unit 3 spirally extend in a circumferential direction of the water collecting pipe 1.

At least one raw water flow channel of the first membrane unit 2 and the second membrane unit 3 spirally extends in a circumferential direction of the water collecting pipe 1.

A waste water outlet 22 of the first membrane unit is in communication with a raw water inlet 31 of the second membrane unit, and when the first membrane unit 2 and the second membrane unit 3 are in an unrolled state, the waste water outlet 22 of the first membrane unit and the raw water inlet 31 of the second membrane unit are located on a same side edge corresponding thereto.

When the first membrane unit 2 and the second membrane unit 3 are in the unrolled state, the first membrane unit 2 and the second membrane unit 3 can be provided in a stacking manner.

The first membrane unit 2 and the second membrane unit 3 can also be arranged in parallel in an axial direction of the water collecting pipe 1.

The waste water outlet 22 of the first membrane unit can be located on a circumferential surface of the membrane element, and the raw water inlet 31 of the second membrane unit can be located on the circumferential surface of the membrane element.

The waste water outlet 22 of the first membrane unit and the raw water inlet 31 of the second membrane unit can be located on an end portion of at least one end of the membrane element.

The first membrane unit 2 and the second membrane unit 3 can be rolled on one water collecting pipe 1 together.

The first membrane unit 2 and the second membrane unit 3 can be rolled on one water collecting pipe 1 together at one time.

In order to further extend the raw water flow channel of the membrane element, in the embodiments of the present application, the waste water outlet 22 of the first membrane unit is in communication with the raw water inlet 31 of the second membrane unit. In the embodiments of the present application, as the raw water flow channel extends, the pure water flow channel remains unchanged, thus the back pressure of pure water 18 remains unchanged. By serial connection of the membrane surfaces or by other means, the water intake pages for raw water 24 are decreased and the flow path is extended, thereby the surface flow rate of the membrane element is increased, the anti-contamination performance of the membrane is improved and the service life of the membrane is prolonged, while the production of pure water 18 of the membrane element under the same water intake pressure remains unchanged.

In the embodiments of the present application, the waste water outlet of the first membrane unit and the raw water inlet of the second membrane unit are located on a same side edge corresponding thereto, which may also facilitate the processing, manufacture and assembly, and the volume of the membrane element with such a structure can be relatively small.

In addition, the first membrane unit 2 and the second membrane unit 3 in the embodiments of the present application are rolled on one water collecting pipe together, such that the volume of the membrane element can be within a relatively small range. Besides, in the embodiments of the present application, the first membrane unit 2 and the second membrane unit 3 can be rolled on one water collecting pipe 1 together at one time, such that the manufacturing method of the membrane element is relatively simple and the processing procedures are less.

Furthermore, in the prior art, the raw water flow channel of a membrane unit usually assume a mode of flowing in from one end of the membrane unit and flowing out from the other end thereof. Whereas, in the embodiments of the present application, the raw water flow channel of at least one of the first membrane unit 2 and the second membrane unit 3 spirally extends in the circumferential direction of the water collecting pipe 1. Since the first membrane unit 2 and/or the second membrane unit 3 are rolled on the water collecting pipe 1, the raw water flow channel of the membrane unit assuming this mode is relatively long.

However, the respective raw water flow channel of the first membrane unit 2 and/or the second membrane unit 3 assuming this mode cannot be extended unlimitedly. With the increase in length of the raw water flow channel, the pure water flow channel of the membrane unit of which the raw water flow channel spirally extends in the circumferential direction of the water collecting pipe 1 also becomes longer correspondingly, and in this case the back pressure of the membrane unit is relatively large, which will easily leads to a decrease in production of pure water 18 of the membrane unit.

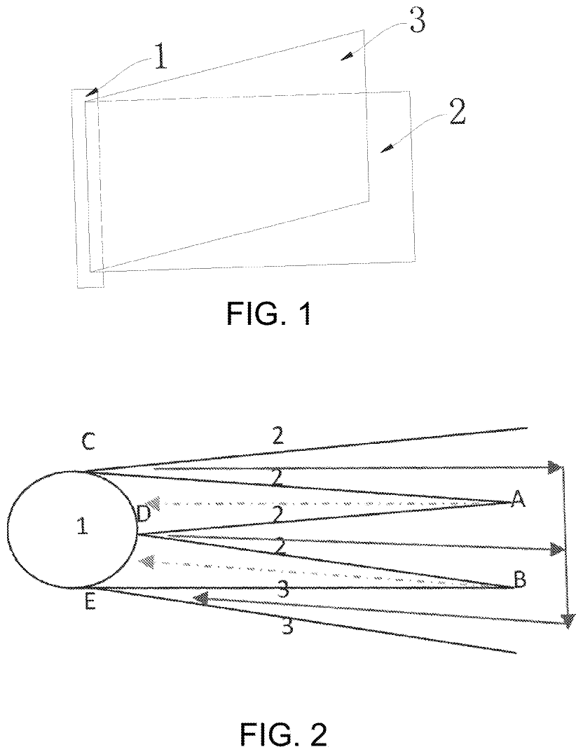

FIGS. 1 to 5 show a specific embodiment of the membrane element of the present application. Referring to FIG. 1, the membrane element in this embodiment comprises a water collecting pipe 1, a first membrane unit 2 and a second membrane unit 3. The first membrane unit 2 and the second membrane unit 3 are rolled on the water collecting pipe 1 together at one time.

When the membrane element is in an unrolled state, the first membrane unit 2 and the second membrane unit 3 are provided in a stacking manner. For example, referring to FIGS. 2, 3 and 4, a raw water flow channel is formed between front surfaces of adjacent first membrane units 2. A raw water flow channel is also formed between front surfaces of adjacent second membrane units 3. Formed on the back surfaces of the first membrane units 2 and the second membrane unit 3 are all pure water flow channels, which all flow to the water collecting pipe 1. The raw water flow channel of the first membrane unit 2 flows in a direction away from the water collecting pipe 1, and the raw water flow channel of the second membrane unit 3 flows in a direction towards the water collecting pipe 1.

The membrane material of the first membrane unit 2 and of the second membrane unit 3 may be the same or different. The membrane material of each of the first membrane units 2 may be the same or different. The membrane material of each of the second membrane units 3 may also be the same or different.

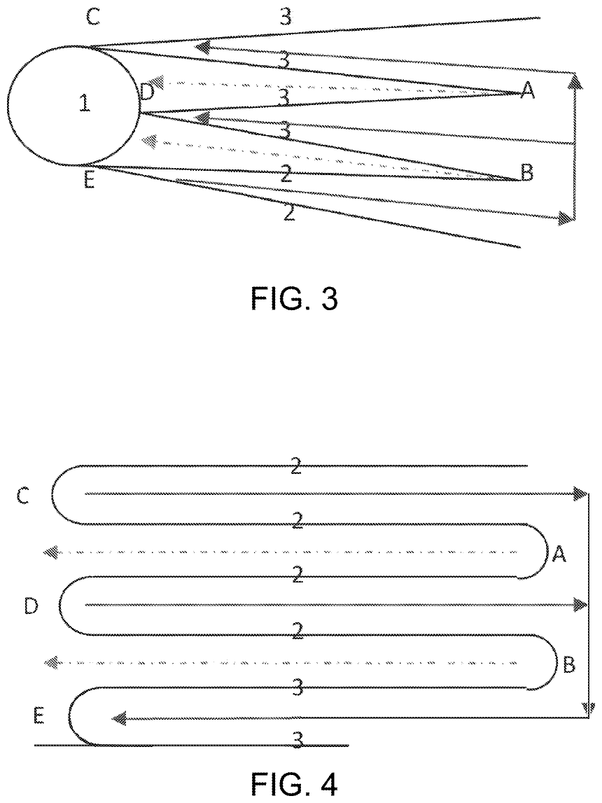

The number of pages of the first membrane units 2 and of the second membrane units 3 is at least two. The number of pages of the first membrane units 2 may be equal or unequal to that of the second membrane units 3. Referring to FIGS. 2 and 4, the number of the first membrane units 2 is greater than that of the second membrane units 3. Referring to FIG. 3, the number of the first membrane units 2 may also be less than that of the second membrane units 3.

Referring to FIGS. 2 and 4, the front surfaces of the membrane pages are sealed at C, D, E (at the water collecting pipe) by means of folding, gluing, etc. (front surfaces face inward, and back surfaces face outward), the back surfaces of the membrane pages are sealed at A, B by means of folding, gluing, etc. (back surfaces face inward and front surfaces face outward), and sealing is also formed at AD, AC and BD, BE of the back surfaces of the membrane pages by gluing, thereby pure water 18 and raw water 24 are separated.

In this embodiment, the raw water flow channels of both the first membrane unit 2 and the second membrane unit 3 spirally extend in a circumferential direction of the water collecting pipe 1. The waste water outlet 22 of the first membrane unit is located on the circumferential surface of the front surface of the membrane element, and the raw water inlet 31 of the second membrane unit is located on the circumferential surface of the front surface of the membrane element. The waste water outlet 22 of the first membrane unit is in communication with the raw water inlet 31 of the second membrane unit.

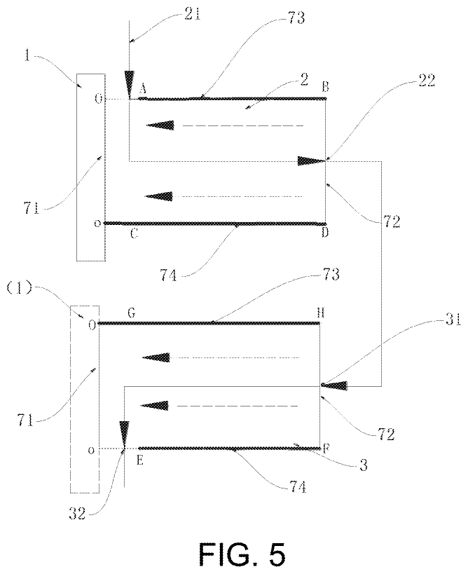

Referring to FIG. 5, when the membrane element is in the unrolled state, the membrane element has a first side edge 71 (left side edge in the figure) and a second side edge 72 (right side edge in the figure), a third side edge 73 (upper side edge in the figure) and a fourth side edge 74 (lower side edges in the figure), wherein the first side edge 71 and the second side edge 72 are opposite to each other, and the third side edge 73 and the fourth side edge 74 are opposite to each other. The third side edge 73 and the fourth side edge 74 are connected with the first side edge 71 and the second side edge 72, respectively.

The side of the first membrane unit 2 and of the second membrane unit 3 which is connected to the water collecting pipe 1 is the first side edge 71 of the membrane element. The pure water outlet of the first membrane unit 2 and the pure water outlet of the second membrane unit 3 are connected to the water collecting pipe 1 located on the first side edge 71. Thereby, pure water 18 produced by the first membrane unit 2 and the second membrane unit 3 can be led out from the water collecting pipe 1. The waste water outlet 22 of the first membrane unit and the raw water inlet 31 of the second membrane unit are located on the second side edge 72 when in the unrolled state. When the membrane element is in the unrolled state, the raw water flow channels of the first membrane unit 2 and the second membrane unit 3 extend along a length direction of the membrane element.

Referring to FIG. 5, the membrane element has a first end (upper end in the figure) and a second end (lower end in the figure) opposite to each other in an axial direction of the water collecting pipe 1. To avoid mixing of water, the raw water inlet 21 of the first membrane unit is located at the first end of the membrane element. The waste water outlet 32 of the second membrane unit is located on the second end of the membrane element. To be specific, the raw water inlet 21 of the first membrane unit is provided on the third side edge 73 of the first membrane unit 2, and the waste water outlet 32 of the second membrane unit is provided on the fourth side edge 74 of the second membrane unit 3. To extend the raw water flow channel as far as possible, the raw water inlet 21 of the first membrane unit can be provided on the third side edge 73 adjacent to the first side edge 71. The waste water outlet 32 of the second membrane unit can be provided on the fourth side edge 74 adjacent to the first side edge 71.

Referring to FIG. 5, a part (section AB) of the third side edge 73 of the first membrane unit 2 on the side of the raw water flow channel other than the raw water inlet 21 of the first membrane unit is sealed, and the fourth side edge 74 (section oD) of the first membrane unit 2 on the side of the raw water flow channel is sealed. A part (section EF) of the fourth side edge 74 of the second membrane unit 3 on the side of the raw water flow channel other than the waste water outlet 32 of the second membrane unit is sealed, and the third side edge 73 (section OH) of the second membrane unit 3 on the side of the raw water flow channel is sealed.

Referring to FIG. 5, in this embodiment, a part of the third side edge 73 of the first membrane unit 2 on the side of the raw water flow channel other than the raw water inlet 21 of the first membrane unit and a part of the third side edge 73 of the second membrane unit 3 on the side of the raw water flow channel other than the part corresponding to the raw water inlet 21 of the first membrane unit (section AB of the third side edge 73 of the first membrane unit 2 and section GH of the third side edge 73 of the second membrane unit 3) are sealed by a first end cap 81. A part of the third side edge 73 of the second membrane unit 3 corresponding to the raw water inlet 21 of the first membrane unit (section OG of the fourth side edge 74 of the second membrane unit 3) is sealed by gluing on a surface of the second membrane unit 3 on the side of the raw water flow channel adjacent to the third side edge 73

A part of the fourth side edge 74 of the second membrane unit 3 on the side of the raw water flow channel other than the waste water outlet 32 of the second membrane unit and a part of the fourth side edge 74 of the first membrane unit 2 on the side of the raw water flow channel except the part corresponding to the waste water outlet 32 of the second membrane unit (section CD of the fourth side edge 74 of the first membrane unit 2 and section EF of the third side edge 73 of the second membrane unit 3) are sealed by a second end cap 82. A part of the fourth side edge 74 of the first membrane unit 2 corresponding to the waste water outlet 32 of the second membrane unit (section oC of the fourth side edge 74 of the first membrane unit 2) is sealed by gluing on a surface of the first membrane unit 2 on the side of the raw water flow channel adjacent to the fourth side edge 74.

It's worth noting that sealing with an end cap in the present application generally refers to applying glue to an end portion of a membrane unit and bonding the end portion to a wall surface of the end cap.

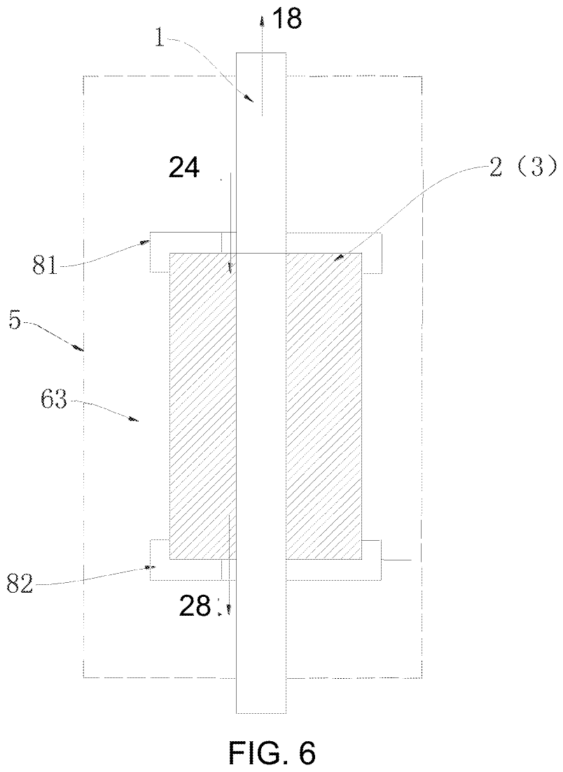

Referring to FIG. 6, the membrane element of the embodiments of the present application may comprise a membrane shell 5 for passage of the water collecting pipe 1 therethrough. The first membrane unit 2 and the second membrane unit 3 are provided within the membrane shell 5, and an interlayer 63 is formed between an outer peripheral surface of the first membrane unit 2 or the second membrane unit 3 and an inner wall of the membrane shell 5, so that the waste water outlet 22 of the first membrane unit is in communication with the raw water inlet 31 of the second membrane unit. The first end cap 81 is provided with a first opening which is in communication with the raw water inlet 21 of the first membrane unit. The second end cap 82 is provided with a second opening which is in communication with the waste water outlet 32 of the second membrane unit.

In this embodiment, waste water 28 generated by the first membrane unit 2 flows, through the waste water outlet on its circumferential surface, into the raw water inlet 31 of the second membrane unit on the circumferential surface. Pure water 18 generated by filtration of the first membrane unit 2 and the second membrane unit 3 is exported outward through the water collecting pipe 1. As such, the raw water flow channel of the membrane element can be basically considered as a superposition of the raw water flow channel of the first membrane unit 2 and the raw water flow channel of the second membrane unit 3. Therefore, for membrane elements according to the embodiments of the present application, a membrane element with a greater membrane surface flow rate will have better anti-contamination performance and a longer serve life, while the production of pure water 18 of the membrane element under the same water intake pressure is unchanged. In addition, in this embodiment, the first membrane unit 2 and the second membrane unit 3 are rolled on one water collecting pipe 1 together at one time, hence the manufacture of the membrane element in this embodiment is relatively simple. Based on the structure of the above filter cartridge, it is clear that the structure of the filter cartridge is relatively simple and the installation thereof is relatively easy.

In an optional embodiment, the first membrane unit 2 and the second membrane unit 3 can be made of the same membrane material. For example, the first membrane unit 2 and the second membrane unit 3 can be reverse osmosis membranes.

In an optional embodiment, considering that waste water 28 from the first membrane unit 2 enters the second membrane unit 3 and the amount of water entering the second membrane unit 3 is less than that flowing from the first membrane unit 2 as the first membrane unit 2 produces some pure water 18, in order to maintain the surface flow rate of the second membrane unit 3, the membrane surface area of the first membrane unit 2 is greater than that of the second membrane unit 3 (i.e. the number of membrane pages of the first membrane unit 2 is greater than that of the second membrane unit 3).

In another optional embodiment, in view of a linear speed of the membrane and other actual situations, the first membrane unit 2 may be plural in number, and the plurality of first membrane units 2 may be made of the same or different filtering membrane materials. Or, the second membrane unit 3 may be plural in number, and the plurality of second membrane units 3 may be made of the same or different filtering membrane materials. Or, the first membrane unit 2 and the second membrane unit 3 may be plural in number, and the plurality of first membrane units 2 and second membrane units 3 may be made of the same or different filtering membrane material.

In another optional embodiment, in order to preserve certain minerals in the produced pure water 18, the first membrane unit 2 and the second membrane unit 3 may be formed by different membranes. For example, the first membrane unit 2 may be a nanofiltration membrane and the second membrane unit 3 may be a reverse osmosis membrane. In this embodiment, in order to ensure the desalination rate of the outlet water and to prevent water scale generated when boiling water, the membrane surface area of the first membrane unit 2 is less than that of the second membrane unit 3 (i.e. the number of membrane pages of the first membrane unit 2 is less than that of the second membrane unit).

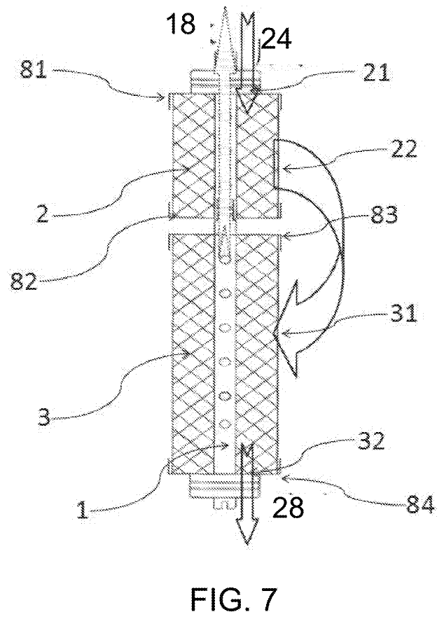

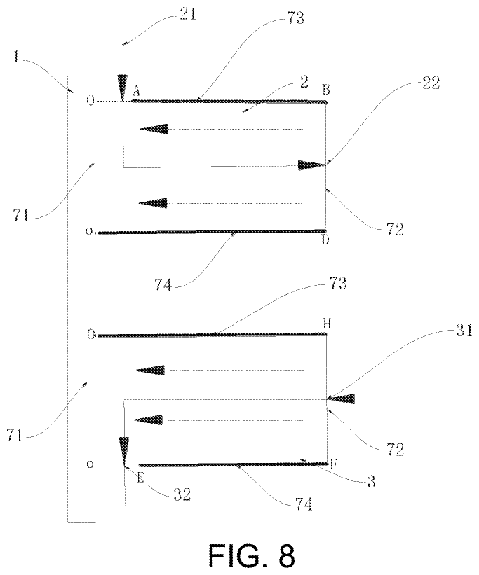

FIGS. 7 to 8 show a specific embodiment of the membrane element of the present application. Referring to FIG. 7, in this embodiment, the waste water outlet 22 of the first membrane unit is located on the circumferential surface of the membrane element, and the raw water inlet 31 of the second membrane unit is located on the circumferential surface of the membrane element. In this embodiment, the raw water flow channels of both the first membrane unit 2 and the second membrane unit 3 spirally extend in the circumferential direction of the water collecting pipe 1. To avoid mixing of water, the raw water inlet 21 of the first membrane unit is located at an upper end of the first membrane unit 2. The waste water outlet 32 of the second membrane unit is located at a lower end of the second membrane unit 3.

Different from the previous embodiment, the first membrane unit 2 and the second membrane unit 3 are arranged at intervals in parallel along the axial direction of the water collecting pipe 1. The first membrane unit 2 and the second membrane unit 3 can be rolled on the water collecting pipe 1 at one time or at two times.

Referring to FIG. 7, in this embodiment, the first membrane unit 2 has a first end (upper end of the first membrane unit 2 in the figure) and a second end (lower end of the first membrane unit 2 in the figure) that are opposite to each other along the axial direction of the water collecting pipe 1, and the second membrane unit 3 has a third end (upper end of the second membrane unit 3 in the figure) and a fourth end (lower end of the second membrane unit 3 in the future) that are opposite to each other along the axial direction of the water collecting pipe 1. The second end of the first membrane unit 2 and the third end of the second membrane unit 3 are provided adjacent to each other.

The membrane element comprises a first end cap 81, a second end cap 82, a third end cap 83 and a fourth end cap 84, which are respectively and correspondingly provided on the first end and the second end of the first membrane unit 2, and on the third end and the fourth end of the second membrane unit 3.

Referring to FIG. 8, a part (section AB) of the third side edge 73 of the first membrane unit 2 on the side of the raw water flow channel other than the raw water inlet 21 of the first membrane unit is sealed by the first end cap 81. The first end cap 81 is provided with a third opening in communication with the raw water inlet 21 of the first membrane unit.

The fourth side edge 74 (section oD) of the first membrane unit 2 on the side of the raw water flow channel is sealed by the second end cap 82.

The third side edge 73 (section OH) of the second membrane unit 3 on the side of the raw water flow channel is sealed by the third end cap 83.

A part (section oF) of the fourth side edge 74 of the second membrane unit 3 on the side of the raw water flow channel other than the waste water outlet 32 of the second membrane unit is sealed by the fourth end cap 84. The fourth end cap 84 is provided with a fourth opening in communication with the waste water outlet 32 of the second membrane unit.

The second end cap 82 and the third end cap 83 respectively seal the fourth side edge 74 of the first membrane unit 2 and the third side edge 73 of the second membrane unit 3, so as to isolate the raw water flow channel of the first membrane unit 2 from that of the second membrane unit 3.

Similar to the previous embodiment, waste water 28 generated by the first membrane unit 2 flows, through the waste water outlet on its circumferential surface, into the raw water inlet 31 of the second membrane unit on the circumferential surface. As such, the raw water flow channel of the membrane element can be basically regarded as a superposition of the raw water flow channel of the first membrane unit 2 and the raw water flow channel of the second membrane unit 3. Therefore, for membrane elements according to the embodiments of the present application, a membrane element with a greater membrane surface flow rate will have better anti-contamination performance and a longer serve life, while the production of pure water 18 of the membrane element under the same water intake pressure is unchanged. In addition, in this embodiment, the first membrane unit 2 and the second membrane unit 3 are rolled on one water collecting pipe 1 together at one time or at two times, hence the manufacture of the membrane element in this embodiment is relatively simple. Compared to the previous embodiment, the cross section area of the membrane element is smaller, but the length of the raw water flow channel is longer.

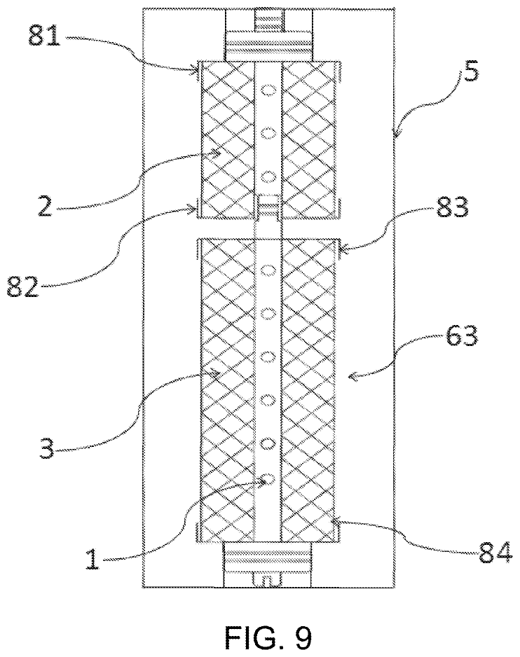

Referring to FIG. 9, the membrane element of the embodiments of the present application may comprise a membrane shell 5 for passage of the water collecting pipe 1 therethrough. The first membrane unit 2 and the second membrane unit 3 are provided within the membrane shell 5, and an interlayer 63 is formed between an outer peripheral surface of the first membrane unit 2 and the second membrane unit 3 and an inner wall of the membrane shell 5, such that the waste water outlet 22 of the first membrane unit is in communication with the raw water inlet 31 of the second membrane unit.

In another optional embodiment, in order to preserve certain minerals in the produced pure water 18, the first membrane unit 2 and the second membrane unit 3 may be formed by different membranes. For example, the first membrane unit 2 may be a nanofiltration membrane, and the second membrane unit 3 may be a reverse osmosis membrane. In this embodiment, in order to ensure the desalination rate of the output water and to prevent water scale generated when boiling water, the membrane surface area of the first membrane unit 2 is less than that of the second membrane unit 3.

For example, in the embodiment in which the first membrane unit 2 and the second membrane unit 3 are provided in parallel along the axial direction of the water collecting pipe 1, a length of the first membrane unit along the axial direction of the water collecting pipe 1 is less than a length of the second membrane unit 3 along the axial direction of the water collecting pipe 1 (as shown in the figure).

Or, in the embodiment in which the first membrane unit 2 and the second membrane unit 3 are provided in a stacking manner, a cross section area of the first membrane unit 2 in a direction perpendicular to the axial direction of the water collecting pipe 1 is less than a cross section area of the second membrane unit 3 in the direction perpendicular to the axial direction of the water collecting pipe 1.

Of course, in other optional embodiments, it is also feasible that the raw water flow channel of one of the first membrane unit 2 and the second membrane unit 3 spirally extends in the circumferential direction of the water collecting pipe 1.

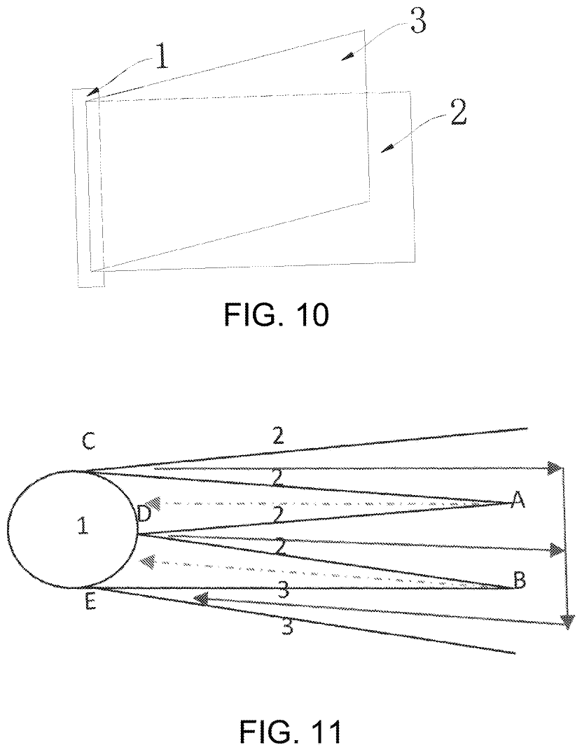

FIGS. 10 to 14 show a specific embodiment of the membrane element of the present application. Referring to FIG. 10, the membrane element in this embodiment comprises a water collecting pipe 1, a first membrane unit 2 and a second membrane unit 3. The first membrane unit 2 and the second membrane unit 3 are rolled on the water collecting pipe 1 together at one time.

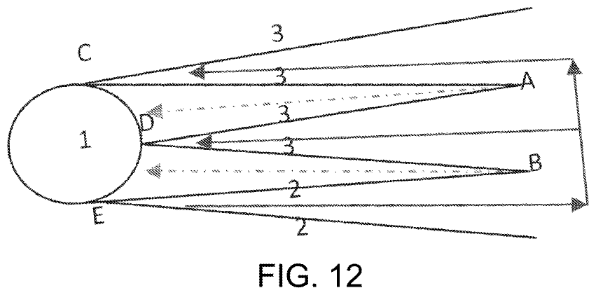

When the membrane element is in the unrolled state, the first membrane unit 2 and the second membrane unit 3 are provided in a stacking manner. For example, referring to FIGS. 11 and 12, a raw water flow channel is formed between front surfaces of adjacent first membrane units 2. A raw water flow channel is also formed between front surfaces of adjacent second membrane units 3. And, formed on the back surfaces of the first membrane units 2 and the second membrane unit 3 are all pure water flow channels, which all flow to the water collecting pipe 1. The raw water flow channel of the first membrane unit 2 flows in a direction away from the water collecting pipe 1, and the raw water flow channel of the second membrane unit 3 flows in a direction towards the water collecting pipe 1.

The membrane material of the first membrane unit 2 and of the second membrane unit 3 may be the same or different. The membrane material of each of the first membrane units 2 may be the same or different. The membrane material of each of the second membrane units 3 may be the same or different.

The number of pages of the first membrane units 2 and of the second membrane units 3 is at least two. The number of pages of the first membrane units 2 may be equal or unequal to that of the second membrane units 3. Referring to FIG. 11, the number of the first membrane units 2 is greater than the number of the second membrane units 3. Referring to FIG. 12, the number of the first membrane units 2 may also be less than the number of the second membrane units 3.

Referring to FIG. 11, the front surfaces of the membrane pages are sealed at C, D, E (on the water collecting pipe) by means of folding, gluing, etc. (front surfaces face inward, and back surfaces face outward), the back surfaces of the membrane pages are sealed at A, B by means of folding, gluing, etc. (back surfaces face inward and front surfaces face outward), and sealing is also formed at AD, AC and BD, BE of the back surfaces of the membrane pages by gluing, thereby pure water 18 and raw water 24 are separated.

In this embodiment, the raw water flow channels of both the first membrane unit 2 and the second membrane unit 3 spirally extend in the circumferential direction of the water collecting pipe 1.

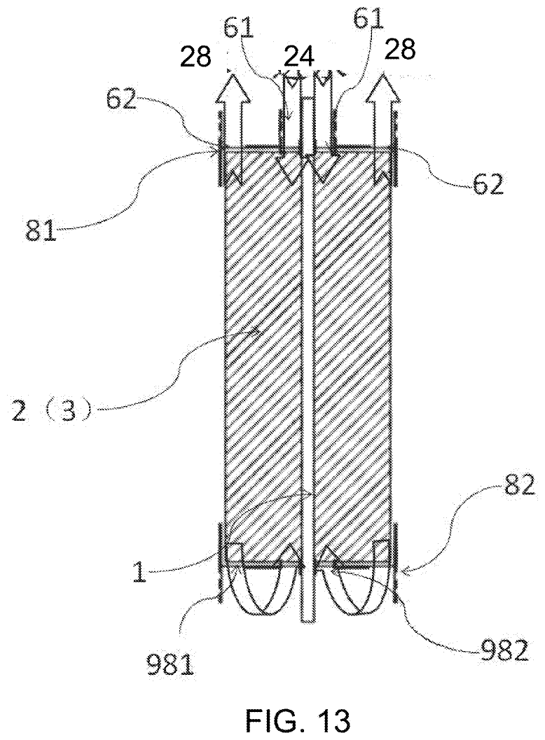

Referring to FIG. 13, the membrane element has a first end (upper end in the figure) and a second end (lower end in the figure) that are opposite to each other along the axial direction of the water collecting pipe 1. The raw water inlet 21 of the first membrane unit is located on the first end of the membrane element. The waste water outlet 22 of the first membrane unit is located on the second end of the membrane element. The raw water inlet 31 of the second membrane unit is located on the second end of the membrane element. The waste water outlet 22 of the first membrane unit is in communication with the raw water inlet 31 of the second membrane unit. The waste water outlet 32 of the second membrane unit is located on the first end of the membrane element.

The membrane element further comprises a first end cap 81 provided on the first end of the membrane element and a second end cap 82 provided on the second end of the membrane element. The first end cap 81 has a first through-hole 61 in communication with the raw water inlet 21 of the first membrane unit and a second through-hole 62 in communication with the waste water outlet 32 of the second membrane unit, and the second end cap 82 has a third through-hole 981 in communication with the waste water outlet 22 of the first membrane unit and a fourth through-hole 982 in communication with the raw water inlet 31 of the second membrane unit. The third through-hole 981 and the fourth through-hole 982 can form communicated flow paths through a membrane shell and the like.

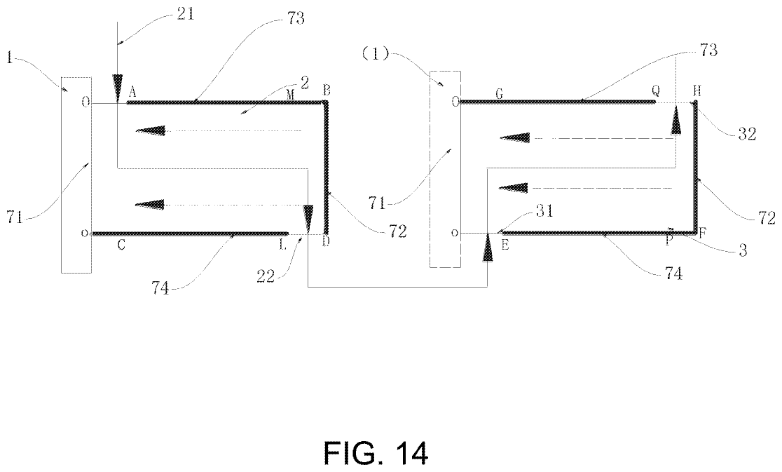

Referring to FIG. 14, the membrane element, in the unrolled state, has a first side edge 71 (left side edge in the figure) connected to the water collecting pipe 1 and a second side edge 72 (right side edge in the figure) opposite to the first side edge 71, and the membrane element, in the unrolled state, also has a third side edge 73 (upper side edges in the figure) and a fourth side edge 74 (lower side edge in the figure) that are opposite to each other, the third side edge 73 and the fourth side edge 74 being respectively connected with the first side edge 71 and the second side edge 72.

The waste water outlet 22 of the first membrane unit is provided on the fourth side edge 74 adjacent to the first side edge 72. The raw water inlet 31 of the second membrane unit is provided on the fourth side edge 74 adjacent to the first side edge 71.

To extend the raw water flow channel as far as possible, the raw water inlet 21 of the first membrane unit is provided on the third side edge 73 adjacent to the first side edge 71. The waste water outlet of the second membrane unit 3 is provided on the third side edge 73 adjacent to the second side edge 72.

In order to isolate the raw water flow channel from the pure water flow channel of the first membrane unit 2 and the second membrane unit 3, a part (section AB) of the third side edge 73 of the first membrane unit 2 on the side of the raw water flow channel other than the raw water inlet 21 of the first membrane unit is sealed; a part (section oL) of the fourth side edge 74 of the first membrane unit 2 on the side of the raw water flow channel other than the waste water outlet 22 of the first membrane unit is sealed; a part (section OQ) of the fourth side edge of the second membrane unit 3 on the side of the raw water flow channel other than the raw water inlet 31 of the second membrane unit is sealed; a part (section EF) of the third side edge 73 of the second membrane unit 3 on the side of the raw water flow channel other than the waste water outlet 32 of the second membrane unit is sealed; and the second side edge 72 of the membrane element is sealed.

Referring to FIG. 14, a part of the third side edge 73 of the first membrane unit 2 on the side of the raw water flow channel other than the raw water inlet 21 of the first membrane unit and the part corresponding to the waste water outlet 32 of the second membrane unit and a part of the third side edge 73 of the second membrane unit 3 on the side of the raw water flow channel other than the part corresponding to the raw water inlet 21 of the first membrane unit and the waste water outlet 32 of the second membrane unit (i.e. section AM of the third side edge 73 of the first membrane unit 2 and section GQ of the third side edge 73 of the second membrane unit 3) are sealed by the first end cap 81. A part of the third side edge 73 of the first membrane unit 2 corresponding to the waste water outlet 32 of the second membrane unit (i.e. section MB of the third side edge 73 of the first membrane unit 2) is sealed by gluing on a surface of the first membrane unit 2 on the side of the raw water flow channel adjacent to the third side edge 73. A part of the third side edge 73 of the second membrane unit 3 corresponding to the raw water inlet 21 of the first membrane unit (i.e. section OG of the third side edge 73 of the second membrane unit 3) is sealed by gluing on a surface of the second membrane unit 3 on the side of the raw water flow channel adjacent to the third side edge.

A part of the fourth side edge 74 of the first membrane unit 2 on the side of the raw water flow channel other than the waste water outlet 22 of the first membrane unit and the part corresponding to the raw water inlet 31 of the second membrane unit and a part of the fourth side edge 74 of the second membrane unit 3 on the side of the raw water flow channel other than the part corresponding to the waste water outlet 22 of the first membrane unit and the raw water inlet 31 of the second membrane unit (i.e. section CL of the fourth side edge 74 of the first membrane unit 2 and section EP of the fourth side edge 74 of the second membrane unit 3) are sealed by the second end cap 82. A part of the fourth side edge 74 of the first membrane unit 2 corresponding to the raw water inlet 31 of the second membrane unit (i.e. section OC of the fourth side edge 74 of the first membrane unit 2) is sealed by gluing on a surface of the first membrane unit 2 on the side of the raw water flow channel adjacent to the fourth side edge 74. A part of the fourth side edge 74 of the second membrane unit 3 corresponding to the waste water outlet 22 of the first membrane unit (i.e. section PF of the fourth side edge 74 of the second membrane unit 3) is sealed by gluing on a surface of the second membrane unit 3 on the side of the raw water flow channel adjacent to the fourth side edge.

The second side edge 72 on the side of the raw water flow channel of the membrane element is sealed by an adhesive tape, so that waste water 28 cannot flow out from the circumferential surface of the membrane element.

In this embodiment, the first membrane unit 2 and the second membrane unit 3 can be made of the same membrane material. For example, the first membrane unit 2 and the second membrane unit 3 can be reverse osmosis membranes.

Of course, the material and number of the first membrane unit 2 and the second membrane unit 3 can be selected according to actual need, and no redundant description will be given here.

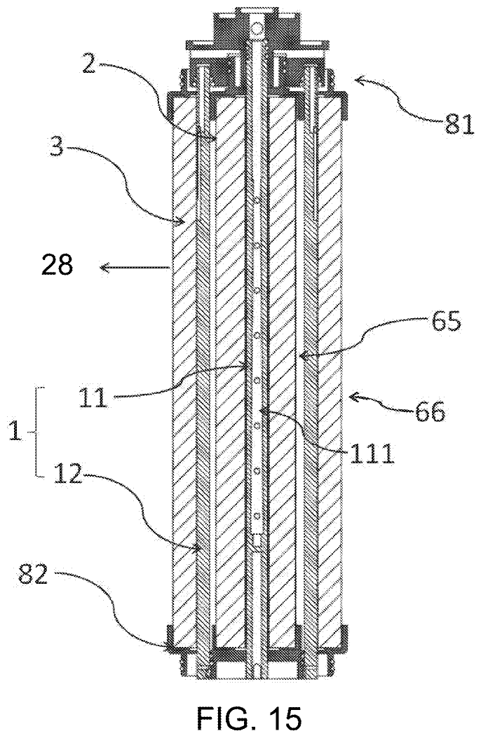

FIGS. 15 to 22 show another specific embodiment of the membrane element of the present application. Referring to FIG. 15, the present application discloses a membrane element comprising a water collecting pipe 1, a first membrane unit 2 and a second membrane unit 3. Raw water flow channels of the first membrane unit 2 and the second membrane unit 3 spirally extend in a circumferential direction of the water collecting pipe 1.

The water collecting pipe 1 comprises a first central pipe 11 and a second central pipe 12 provided over the first central pipe 11. The first membrane unit 2 is rolled on the first central pipe 11, and provided on an inner side of the first central pipe 11 is a first pure water flow guiding channel 111 connected to the pure water outlet of the first membrane unit 2 for collecting pure water 18 produced by filtration by the first membrane unit 2. The second membrane unit 3 is rolled on the second central pipe 12, the second central pipe 12 is provided with a second pure water flow guiding channel 112 connected to the pure water outlet of the second membrane unit 3, and the second pure water flow guiding channel 112 is isolated from an inner side of the second central pipe 12.

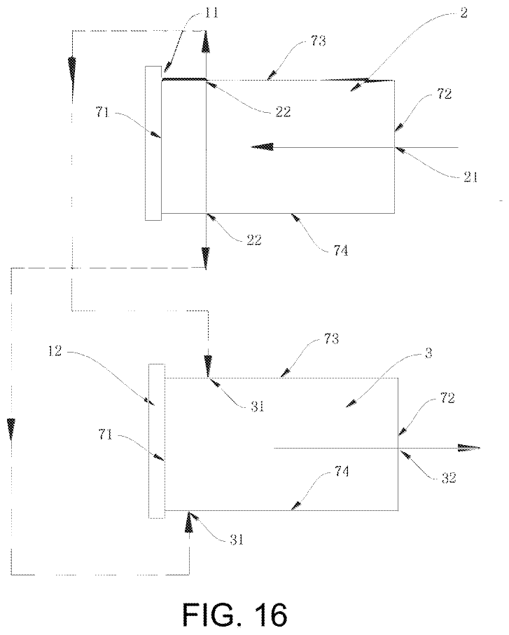

Referring to FIG. 16, when the first membrane unit 2 is in the unrolled state, the first side edge 71 (left side edge in the figure) of the first membrane unit 2 is connected to the first central pipe 11, i.e. the pure water outlet of the first membrane unit 2 is located on the first side edge 71, i.e. the interlayer on the back surface of the first membrane unit 2 is in communication with the first central pipe 11, such that pure water permeated and filtered from the raw water flow channel is collected into the first central pipe 11.

The raw water inlet 21 of the first membrane unit is located on the second side edge 72 opposite to the first side edge 71 (i.e. on the circumferential surface after winding). The waste water outlet 22 of the first membrane unit is provided on the third side edge 73 and the fourth side edge 74. The third side edges 73 and the fourth side edges 74 are respectively connected with the first side edges 71 and the second side edges 72. That is, waste water 28 generated after filtration by the first membrane unit flows out from two ends of the first membrane unit 2. In order to extend the raw water flow channel as far as possible, in this embodiment, the waste water outlet 22 of the first membrane unit is adjacent to the first side edge 71 of the second membrane unit 3 and away from the second side edge 72 thereof.

When the second membrane unit 3 is in the unrolled state, the first side edge 71 (left side edge in the figure) of the second membrane unit 3 is connected to the second central pipe 12, i.e. the pure water outlet of the second membrane unit 3 is located on the first side edge 71, i.e. the pure water outlet of the second membrane unit 3 is in communication with the second central pipe 12, such that pure water permeated and filtered from the raw water flow channel is collected into the second central pipe 12. The waste water outlet 32 of the second membrane unit is located on the second side edge 72 opposite to the first side edge 71 of the second membrane 3 (i.e. on the circumferential surface after winding).

The raw water inlet 31 of the second membrane unit is provided on the third side edge 73 and the fourth side edge 74 of the second membrane unit 3. The third side edge 73 and the fourth side edge 74 are respectively connected with the first side edge 71 and the second side edge 72. That is, the raw water inlet 21 of the first membrane unit is located on two ends thereof. In order to extend the raw water flow channel as far as possible, in this embodiment, the raw water inlet 31 of the second membrane unit is adjacent to the first side edge 71 thereof and away from the second side edge 72 thereof.

Referring to FIG. 15, in this embodiment, a first gap space 65 is formed between an outer wall surface of the first membrane unit 2 and an inner wall surface of the second central pipe 12, such that raw water 24 can enter the first membrane unit 2 from the first gap space 65 via the raw water inlet 21 of the first membrane unit. The membrane element may further comprises a membrane shell 5 (not shown in the figure), and a second gap space 66 is formed between an inner wall surface of the membrane shell 5 and an outer wall surface of the second membrane unit 3, such that waste water 28 generated after filtration by the second membrane unit 3 is exported outward from the second gap space 66.

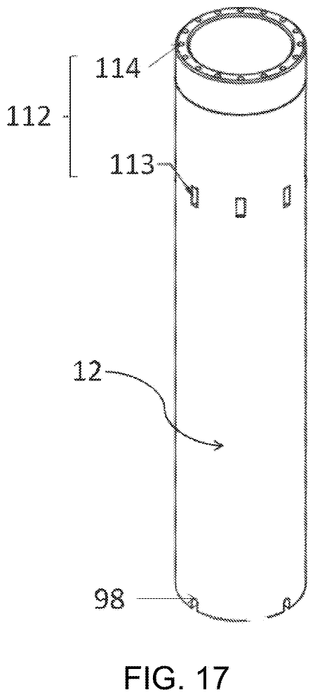

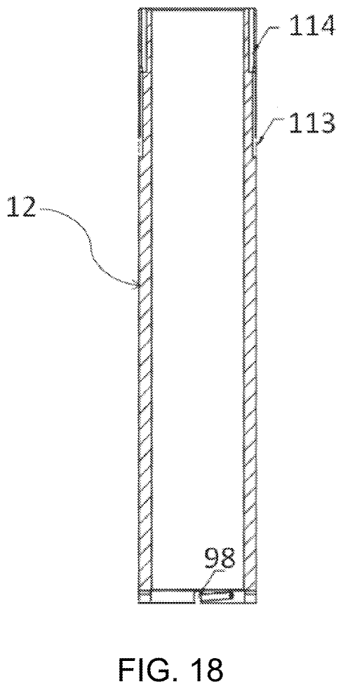

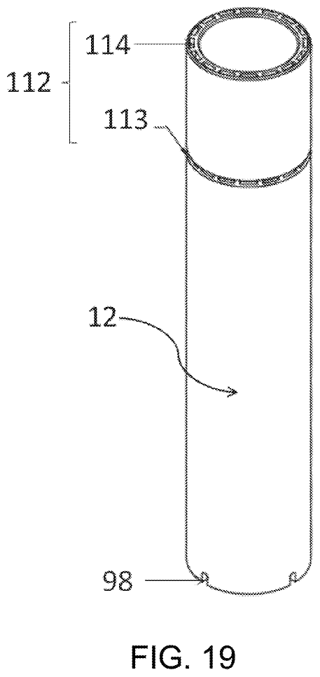

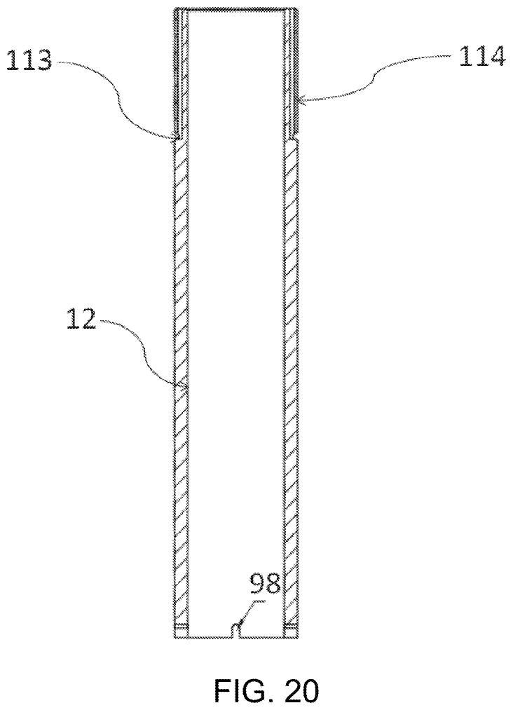

Referring to FIGS. 17 and 18, the second central pipe 12 can be substantially tubular. An inner side of the second central pipe 12 may have a through-hole for provision of the first membrane unit 2 and the first central pipe 11. An outer side wall of the second central pipe 12 can be provided with a plurality of holes arrange in a circumferential direction at intervals (i.e. first channel 113). A second channel 114 extending substantially in an axial direction of the second central pipe 12 can be formed on a wall of the second central pipe 12. The second channel 114 and the first channel 113 are in communication with each other to form a second pure water flow guiding channel 112. And, the second pure water flow guiding channel 112 is isolated from the through-hole, such that pure water 18 produced by the second membrane unit 3 is isolated from the first membrane unit 2. The second channel 114 opens at one end or two ends of the opposite two ends in an axial direction towards the second central pipe 12, such that pure water 18 is exported from the second central pipe 12. Preferably, the number of the first channel 113 is plural, and the plurality of the first channels 113 is arranged at intervals in the circumferential direction of the second central pipe 12, and the second channel 114 extends along the axial direction of the second central pipe 12. Of course, the second central pipe 12 may also have other structures, for example, FIGS. 19 and 20 show another optional embodiment of the second central pipe 12.

The membrane element has a first end and a second end opposite to each other along the axial direction of the water collecting pipe 1. The membrane element may comprise an end cap provided on a same end of the first membrane unit 2 and the second membrane unit 3, the end cap having a channel for communicating the waste water outlet (i.e. the first gap space 65) of the first filtering membrane and the waste water outlet (i.e. the second gap space 66) of the second filtering membrane.

In this embodiment, the waste water outlet 22 of the first membrane unit is located on two ends of the membrane element, and the raw water inlet 31 of the second membrane unit is located on the two ends of the membrane element.

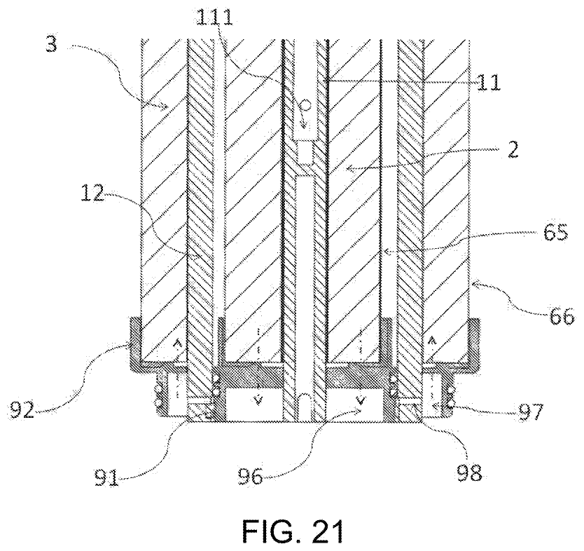

Referring to FIG. 21, to be specific, the membrane element comprises a second end cap 82 located on its lower end. The second end cap 82 comprises a first cap body 91 provided over the first membrane unit 2 and a second cap body provided over the second membrane unit 3, the first cap body 91 having a first space 96 in communication with the waste water outlet of the first filtering membrane, and the second cap body 92 having a second space 97 in communication with the raw water inlet of the second filtering membrane. A fifth through-hole 98 is opened on the side wall of the second central pipe 12 for communicating the first space 96 with the second space 97. The first cap body 91 is adapted to the inner wall of the second central pipe 12 to thereby seal the first gap space 65.

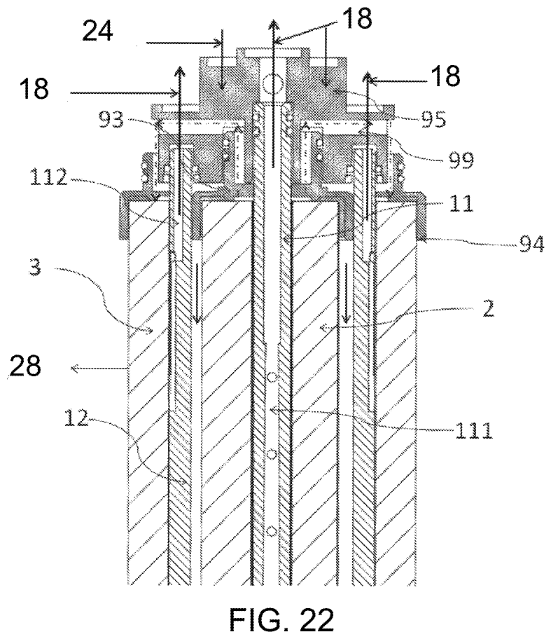

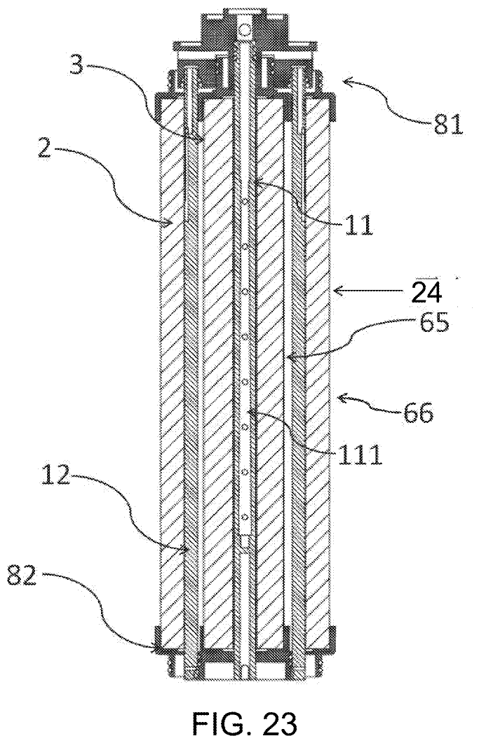

Referring to FIG. 22, the membrane element comprises a first end cap 81 located on its upper end. The first end cap 81 has a first pure water outlet in communication with the first pure water flow guiding channel 111 of the first central pipe 11, a second pure water outlet in communication with the second pure water flow guiding channel 112 of the second central pipe 12 and a waste water channel in communication with the waste water outlet of the second filtering membrane. Preferably, the first end cap 81 has a pure water mixing channel (not shown in the figure) for communicating the first pure water flow guiding channel 111 with the second pure water flow guiding channel 112.

To be specific, the first end cap 81 comprises a third cap body 93 provided over the first membrane unit 2, a fourth cap body 94 provided over the second membrane unit 3 and a fifth cap body 95 provided over an end of the second central pipe 12 and the first central pipe 11. The third cap body 93 is provided with a first hole in communication with the waste water outlet 22 of the first membrane unit and a second hole in communication with the raw water inlet 21 of the first membrane unit, the first hole and the second hole being isolated from each other. An outer wall surface of the third cap body 93 is adapted to the inner wall surface of the second central pipe 12 to thereby seal the first gap space 65. The fourth cap body 94 is provided with a third hole in communication with the waste water outlet 32 of the second membrane unit. The fifth cap body 95 is provided with a first pure water outlet in communication with the first central pipe 11, a second pure water outlet in communication with the second central pipe 12, a waste water channel in communication with a first outlet of the third cap body 93, and a fourth channel 99 for communicating the second hole of the third cap body 93 with the third hole of the fourth cap body 94. To be specific, the fourth channel 99 comprises a first flow path extending along the axial direction of the membrane element and communicating with an end of the first membrane unit 2, a second flow path extending along the axial direction of the membrane element and communicating with an end of the second membrane unit 3, and a third flow path communication with the first and second flow paths and extending in the radial direction of the membrane element.

In this embodiment, raw water 24 entering from the circumferential surface of the first membrane unit 2 is filtered by the first membrane unit 2, and waste water 28 generated thereby enters the raw water flow channel of the second membrane unit 3. That is, the second membrane unit 3 performs filtration again, and pure water 18 is produced again by filtration of the second membrane unit 3. As such, the raw water flow channel of the membrane element can be basically regarded as a superposition of the raw water flow channel of the first membrane unit 2 and the raw water flow channel of the second membrane unit 3. Therefore, for membrane elements according to the embodiments of the present application, a membrane element with a greater membrane surface flow rate will have better anti-contamination performance and a longer serve life, while the production of pure water 18 of the membrane element under the same water intake pressure is unchanged. In this embodiment, the first central pipe 11 and the second central pipe 12 are formed by being provided one over the other, and the second pure water flow guiding channel 112 is provided on the second central pipe 12. In this way, the membrane element has a simple structure and a small volume, and is easy to install. In addition, in this embodiment, the raw water flow channels of both the first membrane unit 2 and the second membrane unit 3 are relatively long, hence the surface flow rate of the membrane is high, the filtration efficiency is high, and the anti-contamination performance is good.

In other optional embodiments, the waste water outlet 32 of the second membrane unit is located on one of the third side edge 73 and the fourth side edge 74, i.e. the waste water outlet 32 of the second membrane unit is located on one end of the second membrane unit. Correspondingly, the raw water inlet 21 of the first membrane unit is also located on one of the third side edge 73 and the fourth side edge 74, i.e. the raw water inlet 21 of the first membrane unit is located on an end corresponding to the waste water outlet 32 of the second membrane unit. For example, both the waste water outlet 32 of the second membrane unit and the raw water inlet 21 of the first membrane unit are located on an upper end. Of course, the structures of the first end cap 81 and the second end cap 82 can also be changed accordingly, and no redundant description thereof will be given here.

In this embodiment, the first membrane unit 2 is a nanofiltration membrane and the second membrane unit 3 is a reverse osmosis membrane. Preferably, a ratio of a surface area of the first membrane unit 2 to a surface area of the second membrane unit 3 is between 1:1 and 1:2.

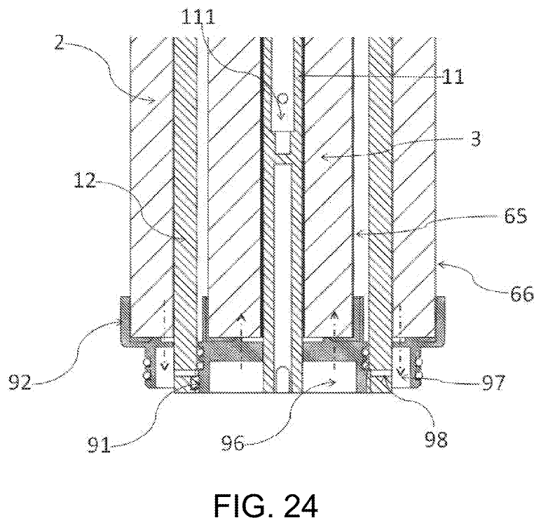

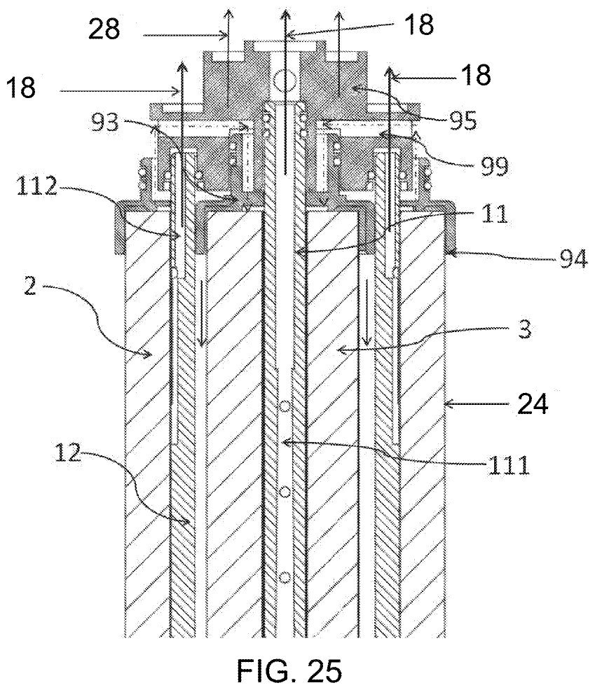

FIGS. 23 to 25 show another specific embodiment of the membrane element of the present application. Referring to FIGS. 23, 24 and 25, in another optional embodiment, different from the previous embodiment, the first membrane unit 2 is rolled on the second central pipe 12, and the second membrane unit 3 is rolled on the first central pipe 11.

In this embodiment, a first gap space 65 is formed between an outer wall surface of the second membrane unit 3 and an inner wall surface of the second central pipe 12, such that waste water 28 generated after filtration by the first membrane unit 2 can enter the second membrane unit 3 from the first gap space 65 via the raw water inlet 31 of the second membrane unit. The membrane element may also comprises a membrane shell 5, and a second gap space 66 is formed between an inner wall surface of the membrane shell 5 and an outer wall surface of the first membrane unit 2, such that raw water 24 can enter the first membrane unit 2 from the second gap space 66 via the raw water inlet 21 of the first membrane unit.

In another optional embodiment, the waste water outlet 22 of the second membrane unit is located on one end of the membrane element. Thus, the raw water inlet 31 of the second membrane unit can also be located on an end of the membrane element corresponding to the waste water outlet 22 of the first membrane unit. For example, the waste water outlet 22 of the first membrane unit and the raw water inlet 31 of the second membrane unit are located on a first end of the membrane element. In the unrolled state, the waste water outlet 22 of the first membrane unit is provided on a third side edge 73 thereof. The raw water inlet 31 of the second membrane unit is also located on the third side edge thereof.

In this embodiment, the first membrane unit 2 and the second membrane unit 3 are both reverse osmosis membranes. Preferably, a ratio of a surface area of the first membrane unit 2 to a surface area of the second membrane unit 3 is between 2:1 and 1:1.

Reference can be made to the previous embodiment for the specific structure of the membrane element in this embodiment, and no redundant description thereof will be given here.

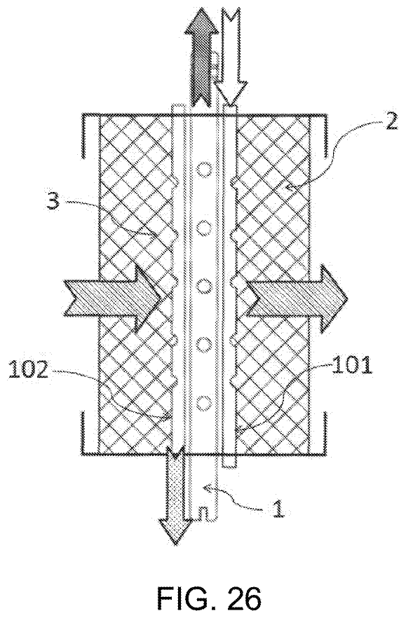

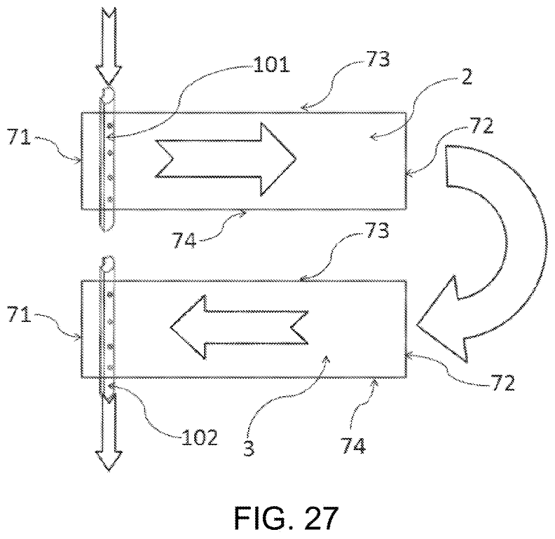

Referring to FIGS. 26 and 27, the embodiments of the present application also disclose a membrane element which further comprises a first water pipe 101 and a second water pipe 102. The first side edge 71 of the first membrane unit 2 on the pure water flow channel side and the first side edge 71 of the second membrane unit 3 on the pure water flow channel side are provided on the water collecting pipe 1. The first water pipe 101 is provided on the first side edge 71 of the first membrane unit 2 on the side of the raw water flow channel, such that the front surface of the first membrane unit 2 is wrapped on the first water pipe 101. The first water pipe 101 comprises a plurality of first flow guiding holes opened on a side wall of the first water pipe 101, a first flow guiding channel extending in an axial direction and used for communication with the plurality of first flow guiding holes, and a first opening provided on an end of the first water pipe 101 and in communication with the first flow guiding channel. Raw water 24 can enter the first flow guiding channel from the first opening and be guided into the first membrane unit 2 from the first flow guiding holes. Under the effect of the first flow guiding holes, raw water 24 can extend spirally in the circumferential direction and flow outward from the second side edge 72 of the first membrane unit 2 (outer periphery after winding). The second water pipe 102 is provided on the first side edge 71 of the second membrane unit 3 on the side of the raw water flow channel, such that the front surface of the second membrane unit 3 is wrapped on the second water pipe 102. The second water pipe 102 comprises a plurality of second flow guiding holes opened on a side wall of the second water pipe 102, a second flow guiding channel extending along the axial direction and used for communication with the plurality of second flow guiding holes, and a second opening provided on an end of the second water pipe 102 and in communication with the second flow guiding channel. Waste water output from the second side edge 72 of the first membrane unit 2 enters the second side edge 72 of the second membrane unit 3 (outer periphery after winding), and flows spirally in the circumferential direction into the second flow guiding hole of the second water pipe 102, then flows into the second flow guiding channel from the second flow guiding hole, and finally flows out from the second opening. In order to separate waste water 28 from raw water 24, the first opening and second opening can be located on two sides of the water collecting pipe 1 respectively.

Preferably, the membrane element, in the unrolled state, has a third side edge 73 and a fourth side edge 74 that are opposite to each other, the third side edge 73 and the fourth side edge 74 being respectively connected with the first side edge 71 and the second side edge 72. The membrane element comprises end caps provided on two ends of the first membrane unit 2 and the second membrane unit 3, for passage of the water collecting pipe 1, the first water pipe 101 and the second water pipe 102 therethrough. The end caps seal the third side edge 73 and fourth side edge 74 of the first membrane unit 2 and the second membrane unit 3.

Further, in order to isolate waste water 28 generated after filtration from raw water 24, the membrane element also comprises a membrane shell and a sealing member. The sealing member is provided between an outer side wall of the end cap and an inner side wall of the membrane shell. The space between two sealing members and the membrane shell can communicate the waste water outlet of the first membrane unit 2 with the raw water inlet of the second membrane unit 3.

In another optional embodiment, the sealing member can be provided over the first water pipe 101 and the second water pipe 102, such that raw water 24 from the first water pipe 101 and waste water 28 from the second water pipe 102 are isolated from the space in the membrane shell.

In another optional embodiment, the sealing member can be wrapped outside the first membrane unit 2 and the second membrane unit 3, such that the sealing member forms, the first membrane unit 2 and the second membrane unit 3 jointly form a sealed space isolated from the space in the membrane shell.

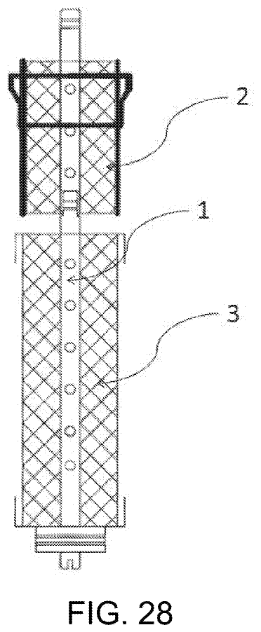

Referring to FIG. 28, the embodiments of the present application also disclose a membrane element comprising a water collecting pipe 1, a first membrane unit 2 provided on the water collecting pipe 1 and a second membrane unit 3 provided on the water collecting pipe 1. The first membrane unit 2 (blue membrane) and the second membrane unit 3 (lateral flow membrane) are arranged at intervals along the axial direction of the water collecting pipe 1. The raw water inlet of the first membrane unit 2 is located on the third side edge 73 thereof, and the waste water outlet is located on the fourth side edge 74 thereof. That is, the raw water flow channel of the first membrane unit 2 extends along the axial direction of the water collecting pipe 1. The raw water inlet of the second membrane unit 3 is located on the second side edge 72 thereof, and the waste water outlet is located on the fourth side edge 74 thereof That is, the raw water flow channel of the second membrane unit 3 spirally extends in the circumferential direction.

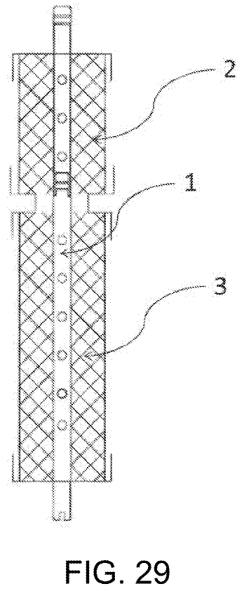

Referring to FIG. 29, the embodiments of the present application also disclose a membrane element comprising a water collecting pipe 1, a first membrane unit 2 provided on the water collecting pipe 1 and a second membrane unit 3 provided on the water collecting pipe 1. The first membrane unit 2 (lateral flow membrane) and the second membrane unit 3 (lateral flow membrane) are arranged at intervals in an axial direction of the water collecting pipe 1. The raw water inlet of the first membrane unit 2 is located on the second side edge 72 thereof, and the waste water outlet is located on the fourth side edge 74 thereof The raw water inlet of the second membrane unit 3 is located on the third side edge 73 thereof, and the waste water outlet is located on the second side edge 72 thereof. That is, the raw water flow channels of the first membrane unit 2 and the second membrane unit 3 spirally extend in a circumferential direction. It's worth noting that a sealing member (such as a rubber ring) is provided between the membrane shell and an end cap provided on an end of the first membrane unit 2 adjacent to the second membrane unit 3 to isolate raw water 24 entering the first membrane unit 2 from waste water 28 generated after filtration by the first membrane unit 2.

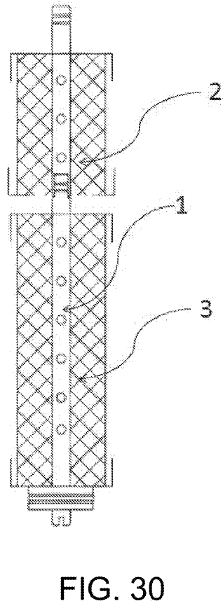

Referring to FIG. 30, the embodiments of the present application also disclose a membrane element comprising a water collecting pipe 1, a first membrane unit 2 provided on the water collecting pipe 1 and a second membrane unit 3 provided on the water collecting pipe 1. The first membrane unit 2 (lateral flow membrane) and the second membrane unit 3 (lateral flow membrane) are arranged at intervals in an axial direction of the water collecting pipe 1. The raw water inlet of the first membrane unit 2 is located on the second side edge 72 thereof, and the waste water outlet is located on the fourth side edge 74 thereof The raw water inlet of the second membrane unit 3 is located on the second side edge 72 thereof, and the waste water outlet is located on the fourth side edge 74 thereof. That is, the raw water flow channels of the first membrane unit 2 and the second membrane unit 3 spirally extend in a circumferential direction. It's worth noting that a sealing member (such as a rubber ring) is provided between the membrane shell and an end cap provided on an end of the first membrane unit 2 adjacent to the second membrane unit 3 to isolate raw water 24 entering the first membrane unit 2 from waste water 28 generated after filtration by the first membrane unit 2.

The embodiments of the present application also disclose a filter cartridge, which comprises the above membrane element.

The embodiments of the present invention are described in a progressive manner, the emphasis of each embodiment is different from that of the other embodiments, and reference can be made to each other for the identical or similar parts of the embodiments.

The above embodiments are intended only for explaining the technical conception and feature of the present invention, with the purpose of enabling the persons who are familiar with this technology to comprehend and implement the content of the invention, and thus cannot limit the scope of protection of the present invention. Any equivalent alteration or modification of the spirit of this application shall be covered by the protection scope of the present application.

What is claimed is:

1. A membrane element, comprising: at least one water collecting pipe, a first membrane unit rolled on the water collecting pipe, and a second membrane unit rolled on the water collecting pipe, at least one raw water flow channel of the first membrane unit and the second membrane unit spirally extends along a circumferential direction of the water collecting pipe, a waste water outlet of the first membrane unit is in communication with a raw water inlet of the second membrane unit.

2. The membrane element according to claim 1, wherein in a state that the first membrane unit and the second membrane unit are unrolled, the wastewater outlet of the first membrane unit and the raw water inlet of the second membrane unit are on a correspondingly same side edge.

3. The membrane element according to claim 2, wherein, the waste water outlet of the first membrane unit is on a circumferential surface of the membrane element and the raw water inlet of the second membrane unit is on the circumferential surface of the membrane element.

4. The membrane element according to claim 3, wherein, the first membrane unit and the second membrane unit are rolled on one water collecting pipe together, the membrane element in the unrolled state has a first side edge connected to the water collecting pipe and a second side edge opposite to the first side edge, and the waste water outlet of the first membrane unit and the raw water inlet of the second membrane unit are on the second side edge when in the unrolled state.

5. The membrane element according to claim 4, wherein, the membrane element
in the unrolled state has a third side edge and a fourth side edge that are opposite to each other, the third side edge and the fourth side edge are respectively connected to the first side edge and the second side edge, the raw water inlet of the first membrane unit is provided on a part of the third side edge adjacent to the first side edge, and the waste water outlet of the second membrane unit is provided on a part of the fourth side edge adjacent to the first side edge.

6. The membrane element according to claim 5, wherein, the third side edge of the first membrane unit on the side of the raw water flow channel is sealed except the raw water inlet of the first membrane unit, and the fourth side edge of the first membrane unit on the side of a raw water flow channel is sealed; the fourth side edge of the second membrane unit on the side of a raw water flow channel is sealed except the waste water outlet of the second membrane unit, and the third side edge of the second membrane unit on the side of a raw water flow channel is sealed.

7. The membrane element according to claim 6, wherein, the first membrane unit and the second membrane unit are provided in a stacking manner when the membrane element is in the unrolled state.

8. The membrane element according to claim 7, wherein, a part of the third side edge of the first membrane unit on the side of the raw water flow channel other than the raw water inlet of the first membrane unit and a part of the third side edge of the second membrane unit on the side of the raw water flow channel other than the part corresponding to the raw water inlet of the first membrane unit are sealed by a first end cap, and a part of the third side edge of the second membrane unit corresponding to the raw water inlet of the first membrane unit is sealed on a surface of the second membrane unit on the side of the raw water flow channel adjacent to the third side edge.

9. The membrane element according to claim 7, wherein, a part of the fourth side edge of the second membrane unit on the side of the raw water flow channel other than the waste water outlet of the second membrane unit and a part of the fourth side edge of the first membrane unit on the side of the raw water flow channel other than the part corresponding to the waste water outlet of the second membrane unit are sealed by a second end cap, and a part of the fourth side edge of the first membrane unit corresponding to the waste water outlet of the second membrane unit is sealed on a surface of the first membrane unit on the side of the raw water flow channel adjacent to the fourth side edge.

10. The membrane element according to claim 6, wherein, the first membrane unit and the second membrane unit are arranged in parallel along an axial direction of the water collecting pipe.

11. The membrane element according to claim 10, wherein, the first membrane unit has a first end and a second end that are opposite to each other along the axial direction of the water collecting pipe, and the second membrane unit has a third end and a fourth end that are opposite to each other along the axial direction of the water collecting pipe, wherein the second end of the first membrane unit and the third end of the second membrane unit are provided adjacent to each other;
the membrane element comprises a first end cap, a second end cap, a third end cap and a fourth end cap, which are respectively and correspondingly provided on the first end and the second end of the first membrane unit, and on the third end and the fourth end of the second membrane unit;
a part of the third side edge of the first membrane unit on the side of the raw water flow channel other than the raw water inlet of the first membrane unit is sealed by the first end cap;
the fourth side edge of the first membrane unit on the side of the raw water flow channel is sealed by the second end cap;
the third side edge of the second membrane unit on the side of the raw water flow channel is sealed by the third end cap;
a part of the fourth side edge of the second membrane unit on the side of the raw water flow channel other than the waste water outlet of the second membrane unit is sealed by the fourth end cap.

12. The membrane element according to claim 4, wherein, a first water pipe adjacent to the first side edge of the first membrane unit is provided in the raw water flow channel of the first membrane unit, and a second water pipe adjacent to the first side edge of the second membrane unit is provided in the raw water flow channel of the second membrane unit, the first water pipe and the second water pipe extending in an axial direction of the water collecting pipe, the first water pipe comprising a plurality of first flow guiding holes opened on a side wall of the first water pipe, a first flow guiding channel extending along the axial direction and used for communication with the plurality of first flow guiding holes, and a first opening provided on an end of the first water pipe and in communication with the first flow guiding channel; and the second water pipe comprising a plurality of second flow guiding holes opened on a side wall of the second water pipe, a second flow guiding channel extending along the axial direction for communication with the plurality of second flow guiding holes, and a second opening provided on an end of the second water pipe and in communication with the second flow guiding channel.

13. The membrane element according to claim 12, wherein, the membrane element in the unrolled state has a third side edge and a fourth side edge that are opposite each other, the third side edge and the fourth side edge are respectively connected with the first side edge and the second side edge, the membrane unit comprises end caps provided on two ends of the first membrane unit and the second membrane unit for passage of the water collecting pipe, the first water pipe and the second water pipe therethrough, and the end caps seal the third side edge and the fourth side edge of the first membrane unit and the second membrane unit.

14. The membrane element according to claim 13, wherein, the membrane element comprises a membrane shell and a sealing member, the sealing member provided between the membrane shell and the end caps, or, the sealing member is provided over the first water pipe and the second water pipe, or, the sealing member is wrapped around an outside the first membrane unit and the second membrane unit.

15. The membrane element according to claim 3, wherein, the membrane element comprises a membrane shell, and a third space in communication with the waste water outlet of the first membrane unit and the raw water inlet of the second membrane unit is formed between the membrane shell and an outer wall surface of the first membrane unit and/or the second membrane unit.

16. The membrane element according to claim 1, wherein, the waste water outlet of the first membrane unit and the raw water inlet of the second membrane unit are located on an end portion of at least one end of the membrane element.

17. The membrane element according to claim 16, wherein, the first membrane unit and the second membrane unit are provided in a stacking manner when the membrane element is in an unrolled state, the first membrane unit and the second membrane unit are rolled on the water collecting pipe together, the waste water outlet of the first membrane unit and the raw water inlet of the second membrane unit are located on one end of the membrane element, and the raw water inlet of the first membrane unit and the waste water outlet of the second membrane unit are located on the other end of the membrane element.

18. The membrane element according to claim 16, wherein, the water collecting pipe comprises a first central pipe and a second central pipe provided over the first central pipe, the first membrane unit is rolled on the first central pipe, and the second membrane unit is rolled on the second central pipe; or, the first membrane unit is rolled on the second central pipe, and the second membrane unit is rolled on the first central pipe.

19. The membrane element according to claim 1, wherein, the first membrane unit and the second membrane unit are made of the same or different membrane material.

20. The membrane element according to claim 1, wherein, the first membrane unit is a nanofiltration membrane and the second membrane unit is a reverse osmosis membrane.

21. The membrane element according to claim 1, wherein, the first membrane unit and the second membrane unit are both reverse osmosis membrane.

22. The membrane element according to claim 21, wherein, a membrane area of the first membrane unit is greater than a membrane area of the second membrane unit.

23. The membrane element according to claim 1, wherein, the number of the first membrane unit is plural, and the plurality of the first membrane units are made of the same or different membrane materials.

24. The membrane element according to claim 1, wherein, the number of the second membrane unit is plural, and the plurality of the second membrane units are made of the same or different membrane materials.

25. The membrane element according to claim 1, wherein, the raw water flow channels of both the first membrane unit and the second membrane unit spirally extend in the circumferential direction of the water collecting pipe.

26. A filter cartridge, comprising a membrane element according to claim 1.

27. A membrane element, comprising:
a water collecting pipe;
a first membrane unit and a second membrane unit rolled on the water collecting pipe together;
a waste water outlet of the first membrane unit being in communication with a raw water inlet of the second membrane unit, the waste water outlet of the first membrane unit and the raw water inlet of the second membrane unit being located on a same side edge corresponding thereto, when the first membrane unit and the second membrane unit are in an unrolled state.

28. The membrane element according to claim 27, wherein, the first membrane unit and the second membrane unit are rolled on the water collecting pipe together at one time.

29. The membrane element according to claim 27, wherein, the first membrane unit and the second membrane unit are provided in a stacking manner when the membrane element is in the unrolled state.

30. The membrane element according to claim 29, wherein, the membrane element, in the unrolled state, has a first side edge connected to the water collecting pipe and a second side edge opposite to the first side edge, and the waste water outlet of the first membrane unit and the raw water inlet of the second membrane unit are located on the second side edge when in the unrolled state.

31. The membrane element according to claim 27, wherein, the first membrane unit and the second membrane unit are arranged in parallel along the axial direction of the water collecting pipe; the membrane element, in the unrolled state, has a first side edge connected to the water collecting pipe and a second side edge opposite to the first side edge, the waste water outlet of the first membrane unit and the raw water inlet of the second membrane unit being located on the second side edge when in the unrolled state; the membrane element, in the unrolled state, has a third side edge and a fourth side edge that are opposite to each other, the third side edge and the fourth side edge being respectively connected with the first side edge and the second side edge, the raw water inlet of the first membrane unit being provided on a part of the third side edge adjacent to the first side edge, and the waste water outlet of the second membrane unit being provided on a part of the fourth side edge adjacent to the first side edge.

32. The membrane element according to claim 27, wherein, the first membrane unit and the second membrane unit are made of the same or different filtering membrane material.

33. The membrane element according to claim 27, wherein, the first membrane unit is a nanofiltration membrane and the second membrane unit is a reverse osmosis membrane.

34. The membrane element according to claim 27, wherein, the first membrane unit and the second membrane unit are both reverse osmosis membrane.

35. The membrane element according to claim 34, wherein, a membrane area of the first membrane unit is greater than a membrane area of the second membrane unit.

36. The membrane element according to claim 27, wherein, the number of the first membrane unit is plural, and the plurality of the first membrane units are made of the same or different filtering membrane materials.

37. The membrane element according to claim 27, wherein, the number of the second membrane unit is plural, and the plurality of the second membrane units are made of the same or different filtering membrane materials.

38. The membrane element according to claim 27, wherein, the raw water flow channels of both the first membrane unit and the second membrane unit spirally extend in the circumferential direction of the water collecting pipe.

39. A filter cartridge, comprising a membrane element according to claim 27.
